(19) United States
(12) Patent Application Publication
(10) Pub. No.: US 2016/0039411 A1
(43) Pub. Date: Feb. 11, 2016

(54) METHOD AND APPARATUS FOR AVOIDING A VEHICLE COLLISION WITH LOW POWER CONSUMPTION BASED ON CONVERSED RADAR SENSORS

(71) Applicants: HYUNDAI MOTOR COMPANY, Seoul (KR); Kia Motors Corporation, Seoul (KR); Pukyong National University Industry-University Cooperation Foundation, Busan (KR)

(72) Inventors: Hong Gi PARK, Seoul (KR); Jee Youl RYU, Busan (KR)

(21) Appl. No.: 14/552,209

(22) Filed: Nov. 24, 2014

(30) Foreign Application Priority Data
Aug. 8, 2014 (KR) 10-2014-0102101

(51) Int. Cl. B60W 30/09; B60W 40/06; G01S 13/02

(52) U.S. Cl. CPC B60W 30/09; G01S 13/02; B60W 40/06

(57) ABSTRACT

A method and apparatus are provided for avoiding a vehicle collision with low power consumption based on converged radar sensors, configured for optimizing collision avoidance between vehicles with a low power consumption by operating a minimum number of sensors according to a road situation in order to reduce a fuel consumption in a high speed driving environment such as a freeway, etc. and a low speed driving environment such as a busy downtown, etc.

### CROSS-REFERENCE TO RELATED APPLICATION

This application is based on and claims priority from Korean Patent Application No. 10-2014-0102101, filed on Aug. 8, 2014 in the Korean Intellectual Property Office, the disclosure of which is incorporated herein in its entirety by reference.

### TECHNICAL FIELD

The present invention relates to a method for optimizing collision avoidance of a vehicle based on very high frequency converged radar sensors (For example, 24 GHz, 77 GHz, . . . etc.), and more particularly, a method and apparatus for optimizing collision avoidance between vehicles with low power consumption in a high speed driving environment such as a freeway, etc. and a low speed driving environment such as a busy downtown, etc.

### BACKGROUND

Recently, due to the convergence of Electronics, Information and Communication, Mechanical and Automotive Engineering, vehicles become increasingly intelligent. In particular, the development of intelligent technology, which enhances the convenience and safety of a driver by automatically detecting the surrounding environment while driving, is recognized as a key technology for future vehicles, and since 1999, many automobile manufacturers including Mercedes-Benz push ahead with it in earnest. Like this, as one of the core system of advanced safe vehicle (ASV), there is ‘vehicle collision warning system’. This system serves as notifying the possibility of a collision or automatically controlling the speed of a vehicle, etc., by detecting the distance between a front car and a rear car with a side, rear and front inter-vehicle distance detection radar in real time.

Thus, a variety of studies have been made for the safety to be able to prevent a vehicle collision in a busy downtown road or a freeway due to a momentary distraction.

Typically, technologies such as Adaptive (responsive) Cruise Control System (ACCS), Forward Vehicle Collision Avoidance System (FVCAS), Side and Backward Vehicle Collision Avoidance System (SBVCAS) and Lane Departure Warning System (LDWS), etc. have been used. In particular, Adaptive Cruise Control System leaves the operation of the steering wheel with the driver and automatically controls the parts controlled by a pedal with a microprocessor. Currently, the control of this adaptive cruise control system is determined by an on/off method and is mainly used in high speed driving more than 40 km/h (i.e., about 25 miles/hour) due to the radar characteristic of 24 GHz FMC method, and thus most of them are the technologies for detecting the obstacles which are far away in a high speed situation in order to prevent the relatively large accident. Also, due to the characteristic of the traffic congestion in downtown, the technology for detecting obstacles by using an ultrasonic sensor for the low speed driving less than 30 km/h and the short distance collision avoidance system configuration has been studied and utilized.

However, ‘The new S-Class’ of Mercedes-Benz released in 2013 has shown Intelligent Drive (function for automatically operating acceleration and brake pedals to maintain the distance from the front car by using a radar sensor and a stereo camera of a car bumper) technology as the most aspiring technology. In particular, in combination with the technology which drives a car in the middle of a lane by reading the road bottom, the driver can do the work such as reading a book or inputting a text message to a mobile phone in the congestion section when stop and go driving is repeated.

Recently, City Safety function introduced in Volvo also used the radar sensor which short distance accuracy is superior in the radar mainly used for detecting obstacles conventionally. However, because these conventional radar sensors operate in a very high frequency such as 24 GHz or 77 GHz, there are problems which the power consumption is increased and thus the fuel efficiency drops.

### SUMMARY OF THE INVENTION

Thus, in order to solve the above problems, the object of the present invention is to provide a method and apparatus for optimizing collision avoidance between vehicles with low power consumption by operating a minimum number of sensors depending on a traffic condition in order to reduce fuel consumption in a high speed driving environment such as a freeway, etc. and a low speed driving environment such as a busy downtown, etc.

Furthermore, the object of the present invention is to provide a method and apparatus for avoiding a collision between vehicles capable of strongly being adapted to a slope road drive, a curve road drive, a bad road condition and a bad weather condition (for example, rain, snow, strong wind, fog, etc.) as well as the accuracy of the collision avoidance can be increased and the occurrence of incorrect information of the radar sensor sensitive to the inter-vehicle distance and environment (for example, road condition, weather condition, etc.) can be reduced, by utilizing an auxiliary device such as a vehicle front camera and 3-axis acceleration sensor and the like.

First, summarizing features of the invention, according to an aspect of the present invention for achieving the above object, a method for avoiding a collision of a vehicle with low power consumption based on a converged radar sensor mounted on the vehicle comprising steps of: (a) operating a plurality of radar sensors; (b) detecting a road condition or a driving environment by analyzing an image of a front camera; (c) obtaining speed information of the vehicle analyzed by using an acceleration sensor and driving information including information for a surrounding vehicle or a surrounding object analyzed by using a radar signal generated by the plurality of radar sensors and a corresponding reflection signal; and (d) supporting a driving state change including a speed of the vehicle or lane change by determining whether a risk for a collision with the surrounding vehicle or the surrounding object exists, while controlling an operation of one front long distance radar sensor and a short distance radar sensor of residual front, rear, or side of the plurality of radar sensors, according to the driving environment or the driving information.

In the (d) step, the method may supports controlling the operation of the plurality of radar sensors and changing the driving state of the vehicle by reflecting at least one of a ground state of a road, whether to run in a slope road, whether to run in a curve road, whether to run in an intersection road, whether to run straight, whether to run in night, whether to run in a leftmost lane, whether to run in a rightmost lane, a weather condition, a speed or acceleration of the vehicle, a relative distance from a preceding vehicle or the surrounding object, or a speed or acceleration of the preceding vehicle.

In (d) step, operation of the front long distance radar sensor is turned off in a speed less than a predetermined speed of the vehicle, and operation of the front long distance radar sensor is turned on in a speed more than a predetermined speed of the vehicle.

In the (d) step, if the vehicle is running in a slope road, or if a state of a road includes a bad weather condition including rain, snow, strong wind or fog situation, or unpaved road situation, operation of the front long distance radar sensor is turned off.

In step (d), if the vehicle is running in a leftmost lane, operation of a left side short distance radar sensor of the plurality of radar sensors is turned off, or if the vehicle is running in a rightmost lane, operation of a right side short distance radar sensor of the plurality of radar sensors is turned off.

In step (d), while supporting a control of acceleration or deceleration of the vehicle by comparing the distance from a vehicle of the front and a left side of the front measured using operation of the front short distance radar sensor and the left side short distance radar sensor of the plurality of radar sensors and a predetermined distance, if it is determined that there is no vehicle in a left lane of the front, while supporting a control of acceleration or deceleration of the vehicle by comparing the distance from a vehicle of the rear and a left side of the rear measured using operation of the front short distance radar sensor and the left side short distance radar sensor of the plurality of radar sensors and a predetermined distance, if it is determined that there is no vehicle in a left lane of the rear, the method may control so as to support the acceleration of the vehicle and to change the lane into the left side lane.

In step (d), while supporting a control of acceleration or deceleration of the vehicle by comparing the distance from a vehicle of the front and a right side of the front measured using operation of the front short distance radar sensor and the right side short distance radar sensor of the plurality of radar sensors and a predetermined distance, if it is determined that there is no vehicle in a right lane of the front, while supporting a control of acceleration or deceleration of the vehicle by comparing the distance from a vehicle of the rear and a right side of the rear measured using operation of the front short distance radar sensor and the right side short distance radar sensor of the plurality of radar sensors and a predetermined distance, if it is determined that there is no vehicle in a right lane of the rear, the method may control so as to support the acceleration of its vehicle and to change the lane into the right side lane.

In step (d), the method may support a control of acceleration or deceleration of the vehicle by comparing the distance from a preceding vehicle measured using operation of the front long distance radar sensor of the plurality of radar sensors and a predetermined distance, and even if it is determined that there is no vehicle in the front, supporting the acceleration of the vehicle.

If a vehicle speed limit exceeds a predetermined high driving speed, only the front long distance radar sensor of the plurality of radar sensors is operated.

In step (c), the method may, by comparing a radar signal generated by the plurality of radar sensors and a corresponding reflection signal, measure a relative voltage difference and a relative phase difference until each of the relative voltage difference and the relative phase difference is same with each of a reference voltage difference and a reference phase difference in a predetermined error range, and by referencing a lookup table of a database, calculate a relative distance from a preceding vehicle or the surrounding object or information for a speed or acceleration of the preceding vehicle corresponding to the reference voltage difference and the reference phase difference as a part of the driving information.

And, according to another aspect of the present invention, an apparatus for avoiding a collision of a vehicle with low power consumption based on a converged radar sensor mounted on the vehicle comprising: a plurality of radar sensors; and a collision avoidance responder configured to perform control of the plurality of radar sensors with a low power consumption and driving control for avoiding a collision of the vehicle, wherein the collision avoidance responder comprises a situation detector configured to detect a road condition or a driving environment by analyzing an image of a front camera; and a distance detector configured to obtain speed information of the vehicle analyzed by using an acceleration sensor and driving information including information for a surrounding vehicle or a surrounding object analyzed by using a radar signal generated by the plurality of radar sensors and a corresponding reflection signal, the collision avoidance responder supports a driving state change including a speed of the vehicle or lane change by determining whether a risk for a collision with the surrounding vehicle or the surrounding object exists, while controlling an operation of one front long distance radar sensor and a short distance radar sensor of residual front, rear, or side of the plurality of radar sensors, according to the driving environment or the driving information.

The plurality of radar sensors may include the front long distance radar sensor, a front short distance radar sensor, a rear short distance radar sensor, a left side short distance radar sensor, and a right side short distance radar sensor.

The plurality of radar sensors may include the front long distance radar sensor operated in 77 GHz, and residual four short distance radar sensors operated in 24 GHz.

The distance detector may turn off operation of the front long distance radar sensor in a speed less than a predetermined speed of the vehicle, and turn on operation of the front long distance radar sensor in a speed more than a predetermined speed of the vehicle.

The situation detector may turn off operation of the front long distance radar sensor, if the vehicle is running in a slope road, or if a state of a road includes a bad weather condition including rain, snow, strong wind or fog situation, or unpaved road situation.

The situation detector may turn off operation of left side short distance radar sensor of the plurality of radar sensors, if the vehicle is running in a leftmost lane, or turn off operation of right side short distance radar sensor of the plurality of radar sensors, if the vehicle is running in a rightmost lane.

The collision avoidance responder, while supporting a control of acceleration or deceleration of the vehicle by comparing the distance from a vehicle of the front and a left side of the front measured using operation of the front short distance radar sensor and the left side short distance radar sensor of the plurality of radar sensors and a predetermined distance, if it is determined that there is no vehicle in a left lane of the front, while supporting a control of acceleration or deceleration of the vehicle by comparing the distance from a vehicle of the rear and a left side of the rear measured using operation of the front short distance radar sensor and the left side short distance radar sensor of the plurality of radar sensors and a predetermined distance, if it is determined that there is no vehicle in a left lane of the rear, may control so as to support the acceleration of the vehicle and to change the lane into the left side lane.

The collision avoidance responder, while supporting a control of acceleration or deceleration of the vehicle by comparing the distance from a vehicle of the front and a right side of the front measured using operation of the front short distance radar sensor and the right side short distance radar sensor of the plurality of radar sensors and a predetermined distance, if it is determined that there is no vehicle in a right lane of the front, while supporting a control of acceleration or deceleration of the vehicle by comparing the distance from a vehicle of the rear and a right side of the rear measured using operation of the front short distance radar sensor and the right side short distance radar sensor of the plurality of radar sensors and a predetermined distance, if it is determined that there is no vehicle in a right lane of the rear, may control so as to support the acceleration of the vehicle and to change the lane into the right side lane.

The collision avoidance responder may support a control of acceleration or deceleration of the vehicle by comparing the distance from a preceding vehicle measured using operation of the front long distance radar sensor of the plurality of radar sensors and a predetermined distance, and support the acceleration of the vehicle, even if it is determined that there is no vehicle in the front.

According to a method and apparatus for avoiding a collision of a vehicle with low power consumption based on converged radar sensor of the present invention, it is possible to avoid a collision between vehicles with low power consumption in a low speed drive less than 60 km/h in a busy downtown, it is also possible to avoid a collision between vehicles with low power consumption in a medium speed drive of 60 km/h 120 km/h in a downtown or a freeway, and it is also possible to avoid a collision between vehicles with low power consumption in a high speed drive of 120 km/h in a freeway. Also, it has the effect capable of reducing fuel consumption by a low power operation of a radar sensor.

Also, by utilizing an auxiliary device such as a vehicle front camera and 3-axis acceleration sensor and the like, it is strongly adapted to a slope road drive, a curve road drive, a bad road condition and a bad weather condition (for example, rain, snow, strong wind, fog, etc.) as well as the accuracy of the collision avoidance can be increased and the occurrence of incorrect information of the radar sensor sensitive to the inter-vehicle distance and environment (for example, road condition, weather condition, etc.) can be reduced, thereby realizing functions such as Adaptive (response) Cruise Control (ACC), Blind Spot Detection (BSD), Lane Change Assist (LCA), Lane Departure Warning (LDW), Lane Keeping Support (LKS), Traffic Sign Recognition (TSR), Rear Cross Traffic Alert (RCTA), Rear Pre Crash (RPC), etc.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an apparatus for avoiding a vehicle collision with low power consumption based on converged radar sensors according to an embodiment of the present invention.

FIG. 2 is a diagram illustrating an arrangement of the converged radar sensors according to an embodiment of the present invention.

FIG. 3 is a diagram illustrating an operation concept of an apparatus for avoiding a vehicle collision according to an embodiment of the present invention.

FIG. 4 is a flow chart of a process of the operation concept of an apparatus for avoiding a vehicle collision according to an embodiment of the present invention.

FIG. 5 is a diagram illustrating a low power consumption driving algorithm of an apparatus for avoiding a vehicle collision according to an embodiment of the present invention.

FIG. 6A, FIG. 6B, and FIG. 6C are a flow chart of a process of a collision avoidance and vehicle control algorithm of an apparatus for avoiding a vehicle collision according to an embodiment of the present invention.

FIG. 7 is flow chart illustrating an example of a database managing algorithm of an apparatus for avoiding a vehicle collision according to an embodiment of the present invention.

### DETAILED DESCRIPTION OF THE PREFERRED EMBODIMENTS

Hereinafter, the present invention will be described in detail with reference to the drawings At this time, in each of the drawings, the same components are denoted by the same reference symbols, if possible. Further, detailed descriptions for the previously known features and/or configurations are omitted. In the description below, parts required to understand operations in accordance with various embodiments will be explained in priority, the descriptions for elements, which may obscure the gist of the descriptions, are omitted. It can also be shown schematically some of the elements in the figures are exaggerated or omitted. Not utterly reflect an actual size to the size of each element, so that they are not intended to limit the content that is specified here by the relative size and spacing of the elements drawn in the figure, respectively.

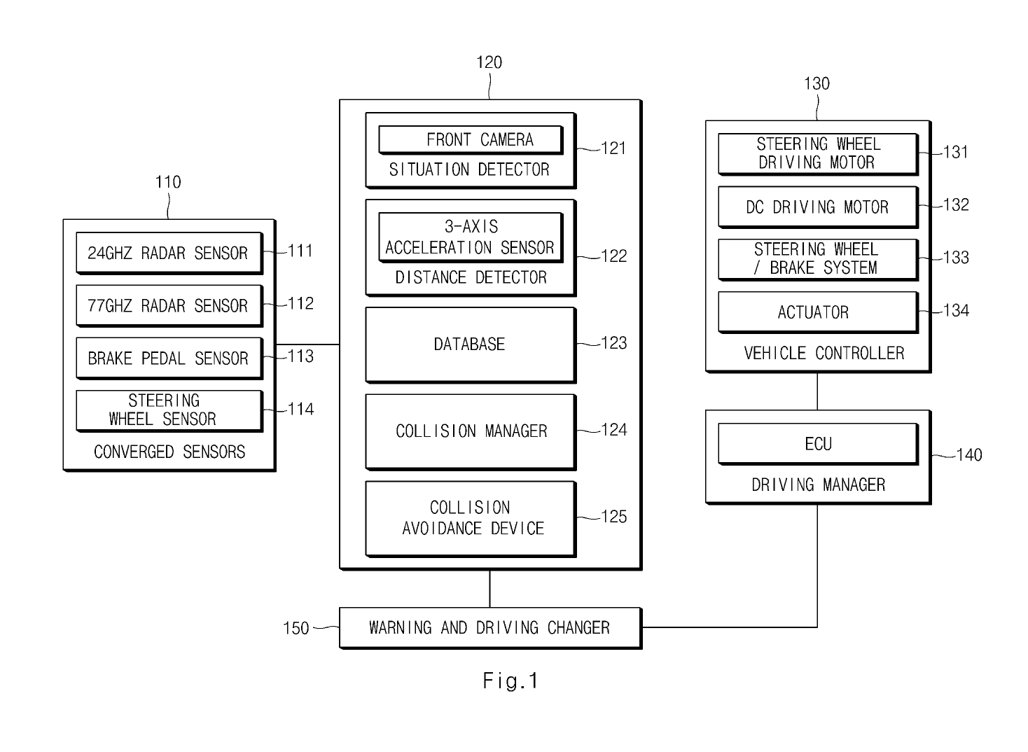

FIG. 1 is a block diagram illustrating an apparatus 100 for avoiding a vehicle collision with low power consumption based on converged radar sensors according to an embodiment of the present invention.

Referring to FIG. 1, an apparatus 100 for avoiding a vehicle collision with low power consumption based on converged radar sensors according to an embodiment of the present invention. As shown, the apparatus 100 includes converged sensors 110, a collision avoidance responder 120, a vehicle controller 130, a driving manager 140, a warning and driving changer 150. The apparatus 100 for avoiding a vehicle collision is mounted on a vehicle and performs the control function for avoiding a vehicle collision with low power consumption, and the configuration of each part of the above can be implemented in a hardware (for example, semiconductor processor), a software, or a combination thereof.

The converged sensors 110 may include a first radar sensor 111 (for example, consisting of operating in 24 GHz), a second radar sensor 112 (for example, operating in 77 GHz), a brake pedal sensor 113, and a steering wheel sensor 114. Here, the first radar sensor 111 may include 4 sensors (not shown) operating in 24 GHz frequency, i.e., SLR (Side Left Radar, 24 GHz), SRR (Side Right Radar, 24 GHz), RCR (Rear Center Radar, 24 GHz) and FCR (Front Center Radar, 24 GHz) sensors, and the second radar sensor 112 may include 1 sensor operating in 77 GHz frequency, (i.e., FCLRR (Front Center Long Range Radar, 77 GHz) sensor).

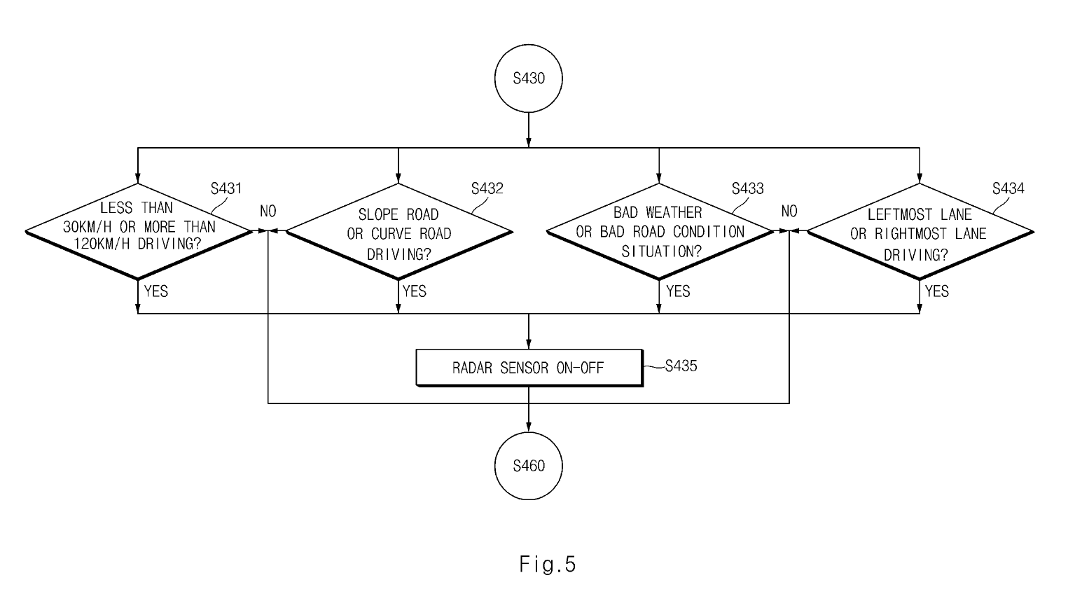

The above converged (24 GHz/77 GHz) radar sensors 111, 112 generate signal data when detecting a vehicle approaching the front, the back, the side, or the blind spot of the driver's vehicle, which is difficult to be recognized by driver, so as to be used for a collision management and avoidance, and in order to determine whether the driver recognizes the potential collision, the brake pedal sensor 113 generates a movement detection signal data of the brake pedal and the steering wheel sensor 114 generates a corresponding movement detection signal data. In the present invention, by using five (5) sensors, hereafter referred to as total 5, i.e., one 77 GHz radar sensor and four 24 GHz radar sensors as described above, the optimal combination is constituted in view of the cost and power consumption of the radar sensor while all detection ranges of surrounding moving vehicles are covered. The converged sensor 110 operates with a situation detector 121 in accordance with the low power driving algorithm shown in FIG. 5, which is the core algorithm of the present invention.

In the following description, the present invention will be described by explaining the operations of the converged (24 GHz/77 GHz) radar sensor 111, 112 which consist of total 5 as described above, but is not limited to these, it may be constituted by a different number of sensors to operate at different frequencies as required, and in this case, the concept of the present invention can be applied similarly.

The collision avoidance responder 120 includes a situation detector 121 including a front camera 311 mounted on a vehicle, a distance detector 122 including a 3-axis acceleration sensor 315, a database 123, a collision manager 124 and a collision manager 125, and the collision avoidance responder 120 is configured to perform the low power control of the radar sensors 111, 112 of the converged sensors 110 and the driving control for avoiding a collision of its vehicle.

The situation detector 121 analyzes a front image taken by the front camera 311, and can detect road conditions such as a ground state of a road, and driving conditions such as slope/curve/intersection/straight driving, night driving, leftmost lane driving, rightmost lane driving and weather condition (for example, rain, snow, strong wind, fog, etc.) and the like. The low power driving algorithm (referring to FIG. 5), which is a core algorithm of the present invention, is applied to the situation detector 121. The front image taken by the front camera 311 and a detection signal provided by the sensors of the converged sensors 110 are used to implement the low power collision avoidance by the low power driving algorithm (referring to FIG. 5).

By using a predetermined relative distance calculation algorithm, the distance detector 122 compares the radar signal (wireless microwave signal) generated from the radar sensors 111, 112 and the received signal reflected from the preceding vehicle and a surrounding object, and can calculate the relative distance from the surrounding vehicle such as the preceding vehicle or the surrounding object, the speed/acceleration of the preceding vehicle by using the relative voltage difference (ΔV) or relative phase difference (Δθ). Also, the distance detector 122 can detect the speed and acceleration information of the vehicle, and whether the vehicle is running in slope/curve/intersection/straight roads by using 3-axis acceleration sensor 315.

The database 123 maintains data measured or calculated in the converged sensors 110, the situation detector 121 and the distance detector 122, so that the data can be used by the comparison calculation of each part. The database 123 may store and manage the radar signal generated by the radar sensors 111, 112 of the converged sensors 110, the received signal reflected from the preceding vehicle or the surrounding object, the analyzed relative voltage difference (ΔV), relative phase difference (Δθ), and the detection signal of the brake pedal sensor 113 and the steering wheel sensor 114, etc. Also, the database 123 may store and manage the front image data taken by the front camera 311 of the situation detector 121, and the road conditions and the information for the driving environment such as slope/curve/intersection/straight driving, night driving, a ground state of a road, leftmost lane driving, rightmost lane driving and weather condition (for example, rain, snow, strong wind, fog, etc.) and the like analyzed by the situation detector 121. Also, database 123 may store and manage the detection signal data of the 3-axis acceleration sensor 315 of the distance detector 122, and the vehicle driving information, etc. including the speed and acceleration information of the vehicle, whether the vehicle is running in slope/curve/intersection/straight roads analyzed by using the detection signal data, and the relative distance from the preceding vehicle or the surrounding object, the speed/acceleration of the preceding vehicle, etc. analyzed or detected as described above.

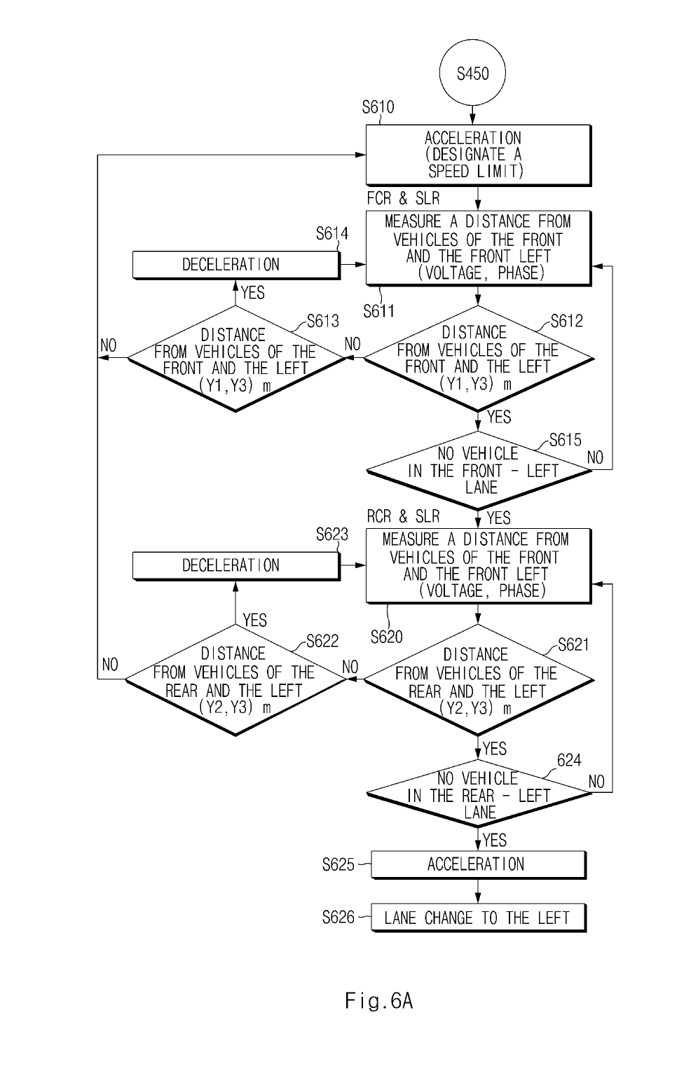

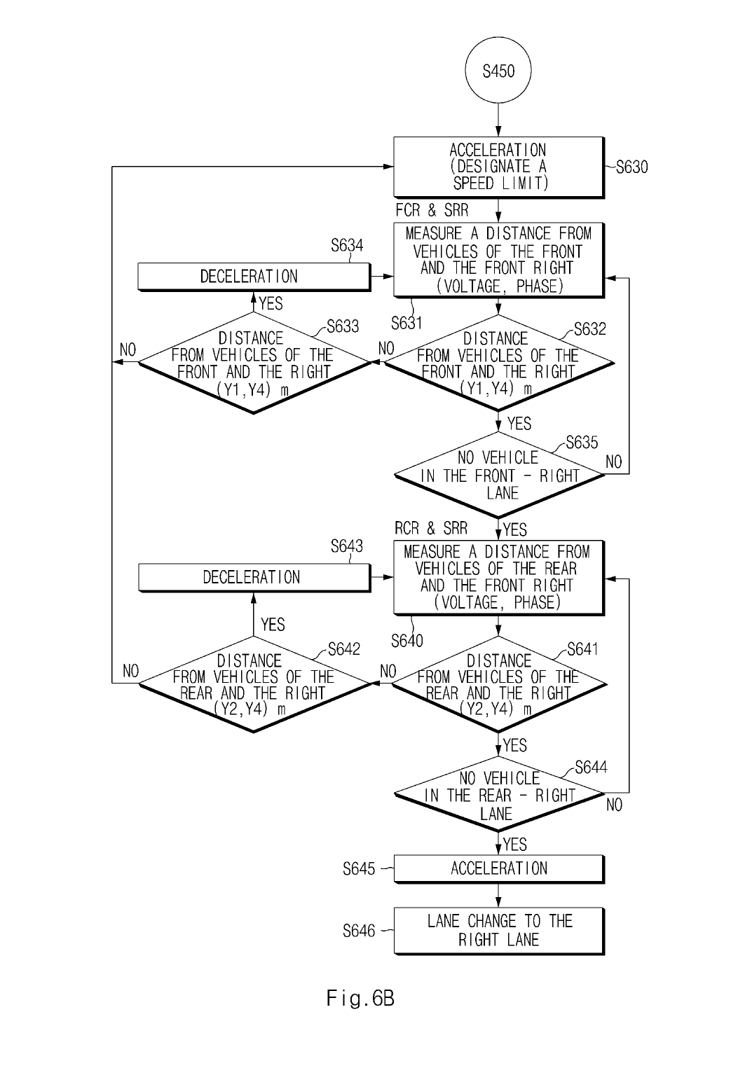

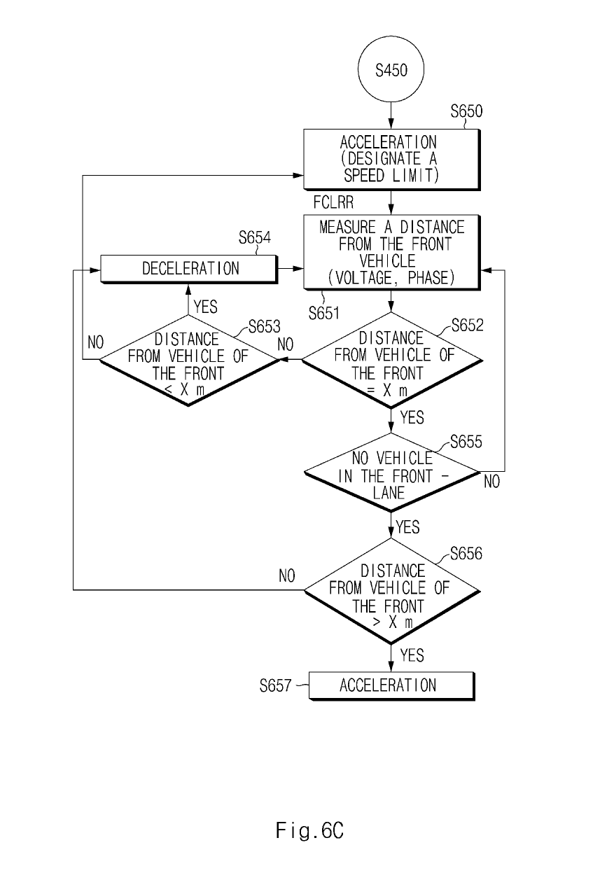

The collision avoidance algorithm of the present invention (referring to FIG. 6) is applied to the collision manager 124 and the collision avoidance device 125.

The collision manager 124 determines whether the risk of collision with the surrounding vehicle or object exists or not by using the database information of the database 123, and analyzes and manage the collision risk by using the collision avoidance algorithm (Referring to FIG. 6).

First, it is divided into cases the relative voltage difference (ΔV) or the relative phase difference (Δθ) is greater than 0, is equal to 0, and is less than 0, and as it is a reference distance element capable of estimating the amount of change in the inter-vehicle distance, each risk can be determined by determining the extent that the distance from the surrounding vehicle or object is getting away or close. The collision manager 124 can determine the risk according to the change of the reference distance element from the above surrounding vehicle or object as described above, and at this time, for example, if the collision is closer than the reference that is a predetermined safety braking distance 2 m, the collision avoidance can be managed to avoid the collision. The collision manager 124 can calculate the speed/acceleration of the vehicle, the speed/acceleration of the preceding vehicle, a collision risk value depending on the relative distance from the preceding vehicle and the surrounding object while tracking the change of the relative voltage difference (ΔV) or the relative phase difference (Δθ).

The collision avoidance device 125 determines front, side, rear collision warnings, assistance for a lane change, warning for rear cross-collision and acceleration/deceleration support, etc. according to the collision risk received from the collision manager 124 by using the database information.

The vehicle control and driving algorithm is applied to the vehicle controller 130 and the driving manager 140.

The vehicle controller 130 may include a steering driving motor 131, a DC driving motor 132, a steering wheel/brake system 133, and an actuator 134, and by controlling these, can control the driving of the vehicle such as the acceleration/deceleration of the vehicle. The vehicle controller 130 is configured to perform the angle control of the front wheel of the vehicle for changing the lane through the vehicle acceleration by controlling the steering wheel driving motor 131 interoperated with the wheel/brake system 133, perform the rear wheel of the vehicle for accelerating the vehicle by controlling the DC driving motor 132, and perform the control for decelerating the vehicle by the actuator 134 interoperated with the wheel/brake system 133 for avoiding a collision, according to the collision risk received from the collision manager 124.

In order to determine whether the steering wheel is operated, whether the steering wheel sensor and brake pedal sensor are operated, whether the DC motor is operated, whether the speed of the vehicle is controlled, etc. according to the driving condition such the road condition and the weather condition, the driving manager 140 capable of including ECU (Engine Control Unit) is configured to receive the information for the operating signals of the brake pedal sensor 113, the steering wheel sensor 114, steering wheel driving motor 131, the DC driving motor 132, actuator 134, etc. from ECU, and analyze the driving pattern depending on it.

An warning and driving changer 150 is configured to output the warning for notifying the collision risk to a speaker according to the collision avoidance algorithm (referring to FIG. 6) of the collision avoidance responder 120 or display the warning to a display device, and controls each part required for changing the control of the vehicle for a predetermined running performance such as soft driving comfort, etc. by changing the vehicle driving such as the acceleration/deceleration of the vehicle, etc. according to the driving control based on the driving pattern analyzed by the driving manager 140.

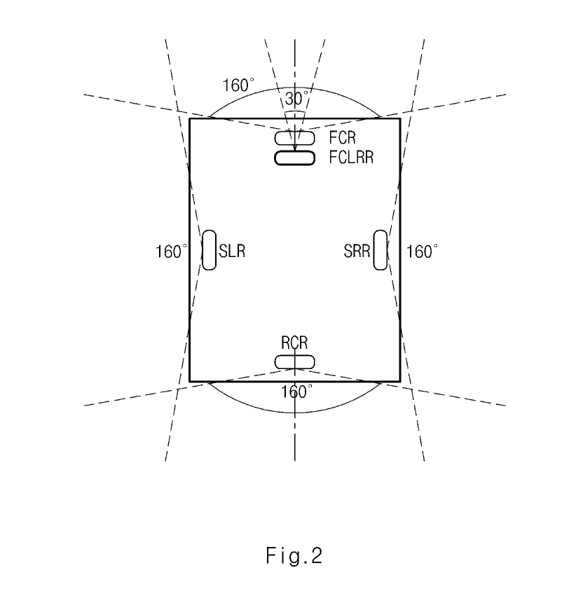

FIG. 2 is a diagram illustrating an arrangement of the converged radar sensors 111, 112 according to an embodiment of the present invention.

In FIG. 2, as the example of the first radar sensor 111 (for example, consisting of four operating in 24 GHz), SLR (Side Left Radar, 24 GHz) mounted on the left side, SRR (Side Right Radar, 24 GHz) mounted on the right side, RCR (Rear Center Radar, 24 GHz) mounted on the rear center and FCR (Front Center Radar, 24 GHz) mounted on the front center are shown, and as the example of the second radar sensor 112 (for example, operating in 77 GHz), FCLRR (Front Center Long Range Radar, 77 GHz) mounted on the front center is shown. By using total 5, i.e., one 77 GHz radar sensor and four 24 GHz radar sensors, the optimal combination is constituted in view of the cost and power consumption of the radar sensor while all detection ranges of surrounding moving vehicles are covered.

For example, FCLRR (Front Center Long Range Radar, 77 GHz) sensor for monitoring the front long distance in order to detect an object within 150 m of the front is arranged in the top of the center of the vehicle front bumper. The azimuth of the radar signal beam can have the angle of left and right 30 degrees (30°) and the angle of up and down 10°. Also, FCR (Front Center Radar, 24 GHz) sensor for monitoring the front short distance in order to detect an object within 30 m of the front radius is arranged in the bottom of the center of the vehicle front bumper. The azimuth of the radar signal beam of the FCR sensor can have the angle of left and right 160° and the angle of up and down 10°. Also, SLR (Side Left Radar, 24 GHz) and SRR (Side Right Radar, 24 GHz) sensors for monitoring the side in order to detect an object within 30 m radius are each arranged in the center of the left side and right side of the vehicle or a side mirror. At this time, the azimuth of the radar signal beam can have the angle of left and right 160° and the angle of up and down 10°. RCR (Rear Center Radar, 24 GHz) sensor for monitoring the rear short distance in order to detect an object within 30 m of the rear radius is arranged in the center of the vehicle rear bumper. At this time, the azimuth of the radar signal beam can have the angle of left and right 160 and the angle of up and down 10

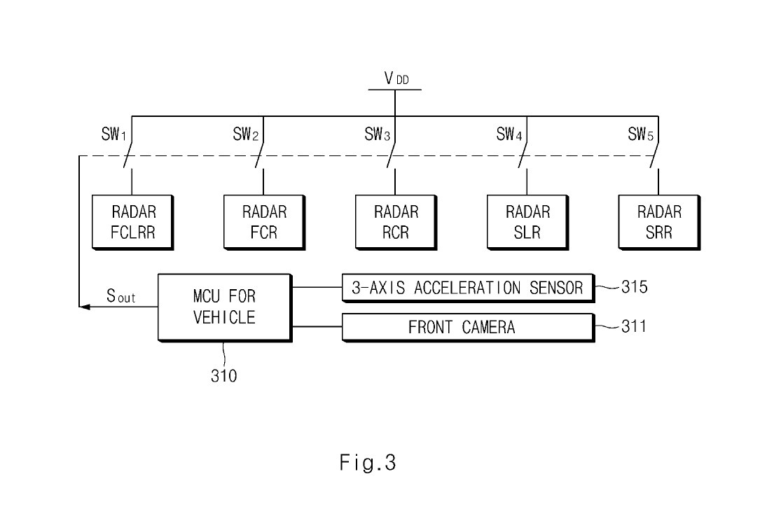

FIG. 3 is a diagram illustrating an operation concept of an apparatus for avoiding a vehicle collision according to an embodiment of the present invention.

As shown in FIG. 3, in the present invention, by controlling on and off of 5 switches (SW₁˜SW₅) according to the situation using a MCU (Micro Controller Unit) of the vehicle, the selected sensor of 5 radar sensors (SLR, SRR, RCR, FCR, FCLRR) constituting an optimal combination can operate with low power consumption by receiving the power supply (V_{DD}).

According to the information detecting road conditions and driving conditions such as slope/curve/intersection/straight driving, night driving, a ground state of a road, leftmost lane driving, rightmost lane driving and weather condition (for example, rain, snow, strong wind, fog, etc.) and the like detected by the situation detector 121 by analyzing the front image taken by a front camera 311, or the vehicle driving information detecting the speed and acceleration information of the vehicle, and whether the vehicle is running in slope/curve/intersection/straight roads detected by the distance detector 122 by using 3-axis acceleration sensor 315, the MCU for vehicle controls the low power driving by outputting the switch control signal Sₒᵤₜ and selectively controlling on and off of 5 switches (SW₁˜SW₅) depending on the corresponding situation as below.

The whole or part of the apparatus for avoiding a vehicle collision (100) of FIG. 1 can be implemented by the above described MCU for vehicle, semiconductor processor.

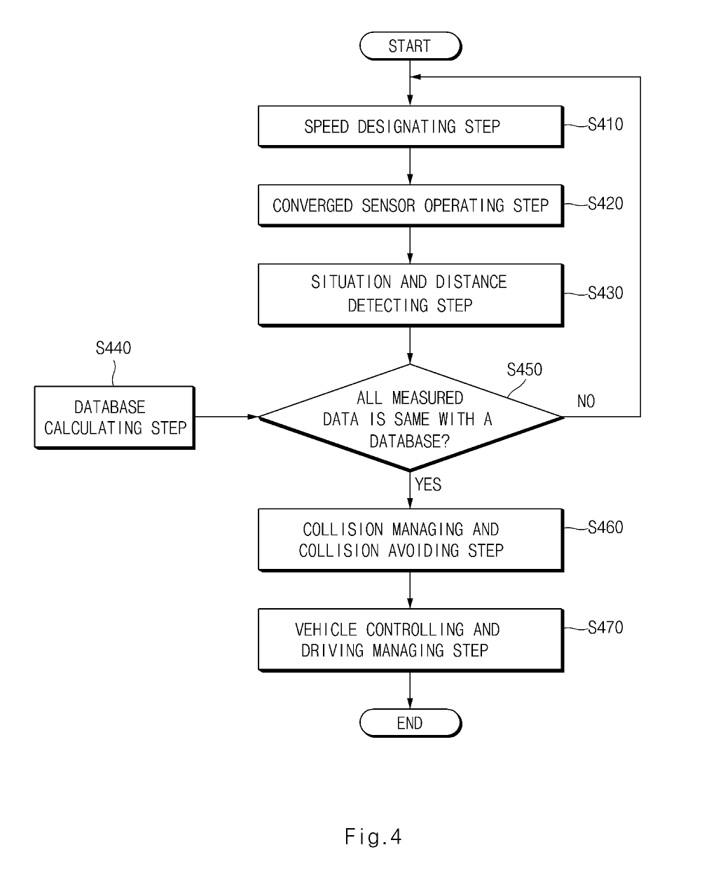

FIG. 4 is a flow chart of a process of the operation concept of an apparatus for avoiding a vehicle collision according to an embodiment of the present invention.

First, in the speed designation step S410, through the collision avoidance device 125, the vehicle speed limits of 3 steps including for example, the low speed driving less than 60 km/h, the medium speed driving of 60˜120 km/h, and the high speed driving more than 120 km/h can be previously designated.

According to the information detecting road conditions and driving conditions such as slope/curve/intersection/straight driving, night driving, a ground state of a road, leftmost lane driving, rightmost lane driving and weather condition (for example, rain, snow, strong wind, fog, etc.) and the like analyzed by using the front camera 311, or the vehicle driving information detecting the speed and acceleration information of the vehicle, and whether the vehicle is running in slope/curve/intersection/straight roads by using 3-axis acceleration sensor 315, as described below, for example, the speed of the vehicle is controlled to drive in a high speed more than 120 km/h in good ground state of a road, the speed is controlled to drive in a low speed less than 60 km/h in bad ground state of a road such as a slope road, a curve road and an unpaved road, etc., and the speed is controlled to drive in a medium speed of 60˜120 km/h when the weather condition is bad (rain, snow, strong wind, fog, etc.), even good ground state of a road.

Here, although an example of 3 steps separated by the low speed driving, the medium speed driving, the low speed driving is described as the vehicle speed limit sections, the present invention is not limited thereto, in some cases, it can be separated by 5 steps such as less than 30 km/h, 30˜60 km/h, 60˜90 km/h, 90˜120 km/h and more than 120 km/h, and if necessary, more or less steps in the vehicle speed limit can also be operated in separate sections.

In the converged sensor operating step S420, very high frequency converged (24 GHz/77 GHz) radar sensors 111, 112 for detecting the vehicle or object approaching to the front, the side, the rear and the blind spot are operated, and then radar sensors 111, 112 generate the radar signal and receive the radar signal reflected from the surrounding vehicle or object. In the present invention, by using total 5, i.e., one 77 GHz radar sensor and four 24 GHz radar sensors, the optimal combination is constituted in view of the cost and power consumption of the radar sensor while all detection ranges of surrounding vehicles or objects are covered. Also, in order to determine whether the driver recognizes the collision, the brake pedal sensor 113 is operated and then the signal data detecting the movement of the brake pedal is generated, and the steering wheel sensor 114 is operated and then the signal data detecting the corresponding movement is generated.

The situation and distance detecting step S430 is composed of the situation detecting step and the distance detecting step.

First, in the situation detecting step, the situation detector 121 analyzes the front image taken by a front camera 311, and can detect road conditions and driving conditions such as slope/curve/intersection/straight driving, night driving, a ground state of a road, leftmost lane driving, rightmost lane driving and weather condition (for example, rain, snow, strong wind, fog, etc.) and the like. At this time, by detecting the lane and curvature of the lane from the image, the detection information for the road conditions and the driving conditions is generated and thus the vehicle can be controlled depending on the detection information. The front image taken by the front camera 311 and a detection signal data of the present invention taken from the sensors of the converged sensors 110 are used to implement the low power collision avoidance by the low power driving algorithm (referring to FIG. 5) which is a core algorithm of the present invention.

In the distance detecting step, by using a predetermined relative distance calculation algorithm, the distance detector 122 compares the radar signal (wireless microwave signal) generated from the radar sensors 111, 112 and the received signal reflected from the preceding vehicle or a surrounding object, and can calculate the relative distance from the preceding vehicle or a surrounding object, the speed/acceleration of the preceding vehicle, etc., by using the relative voltage difference (ΔV) or relative phase difference (Δθ). Also, the distance detector 122 can detect the speed and acceleration information of the vehicle, and whether the vehicle is running in slope/curve/intersection/straight roads by using 3-axis acceleration sensor 315.

In the database calculating step S440, the database 123 maintains data measured or calculated in the converged sensors 110, the situation detector 121 and the distance detector 122, so that the measured or calculated data can be used by the comparison calculation of each part. This process is performed until all data required to the collision avoidance algorithm of the present invention are collected by completing the measurement, calculation, analysis and detection, etc. in the converged sensors 110, the situation detector 121 and the distance detector 122 (S450).

In the collision managing and avoidance step S460, as described below in detail, the collision manager 124 calculates and manages the speed/acceleration of the vehicle, the speed/acceleration of the preceding vehicle, a collision risk value depending on the relative distance from the preceding vehicle and the surrounding object while tracking the change of the relative voltage difference (ΔV) or the relative phase difference (Δθ) by using the database information of the database 123, and the collision avoidance device 125 determines front, side, rear collision warnings, assistance for a lane change, warning for rear cross-collision and acceleration/deceleration support, etc. according to the collision risk received from the collision manager 124 by using the database information.

In the vehicle control and driving managing step S470, the vehicle control and driving algorithm is applied, and the vehicle controller 130 is configured to perform the angle control of the front wheel of the vehicle for changing the lane through the vehicle acceleration by controlling the steering wheel driving motor 131 interoperated with the wheel/brake system 133, perform the rear wheel of the vehicle for accelerating the vehicle by controlling the DC driving motor 132, and perform the control for decelerating the vehicle by the actuator 134 interoperated with the wheel/brake system 133 for avoiding a collision, according to the collision risk received from the collision manager 124. Also, in order to determine whether the steering wheel is operated, whether the steering wheel sensor 114 and brake pedal sensor 113 are operated, whether the DC motor is operated, whether the speed of the vehicle is controlled, etc. according to the driving condition such the road condition and the weather condition, the driving manager 140 can receive the information for the operating signals of the brake pedal sensor 113, the steering wheel sensor 114, steering wheel driving motor 131, the DC driving motor 132, actuator 134, etc. from ECU (Engine Control Unit) as driving information, and analyze the driving pattern depending on it.

Thus, the warning and driving changer 150 can output the warning for notifying the collision risk to a speaker according to the collision avoidance algorithm (referring to FIG. 6) of the collision avoidance responder 120 or display the warning to a display device, and controls each part required for changing the control of the vehicle for a predetermined running performance such as soft driving comfort, etc. by changing the vehicle driving such as the acceleration/deceleration of the vehicle, etc. according to the driving control based on the driving pattern analyzed by the driving manager 140.

FIG. 5 is a diagram illustrating a low power consumption driving algorithm of an apparatus 100 for avoiding a vehicle collision according to an embodiment of the present invention.

As described in FIG. 3, by properly controlling on and off of 5 switches (SW₁˜SW₅) which switch the operation of radar sensors (SLR, SRR, RCR, FCR, FCLRR) according to the situation, the radar sensors (SLR, SRR, RCR, FCR, FCLRR) which are electric device loads of the vehicle can be operated with a low power to reduce the fuel consumption. The fuel consumption according to the operation of the electric device load is proportional to the time which the power is used. For example, according to the statistical data, in a normal gasoline engine vehicle, the fuel of 1 cc can be consumed during 1 minute per 100 W power consumption amount, and the fuel of 5.3 cc/minute can be consumed if the reference is total power consumption amount of 550 W per one vehicle.

The power consumption for each of radar sensors (SLR, SRR, RCR, FCR, FCLRR) can be calculated as following Equation 1.

P=P_{S}+P_{D}=V_{DD}I_{D}(=RI_{D}²=V_{DD}²/R)+af²CV_{DD} [Equation 1]

Here, P_{S} is an operating power of the sensor itself, P_{D} is a power of a drive circuit for driving the sensor, V_{DD} is a direct current voltage applied to sensors, I_{D} is a direct current supplied to sensors, R is the sensor resistance, a is a proportional constant, f is a sensor operating frequency (for example, 24 GHz or 77 GHz), C represents a capacitance included in sensors. In the present invention, by using total 5, i.e., one 77 GHz radar sensor and four 24 GHz radar sensors as described above, the optimal combination is constituted in view of the cost and power consumption of the radar sensor while all detection ranges of surrounding vehicles or objects are covered.

In the situation and distance detecting step of FIG. 5, as described in FIG. 4, the situation detector 121 and the distance detector 122 are operated, and according to the information detecting road conditions and driving conditions such as slope/curve/intersection/straight driving, night driving, a ground state of a road, leftmost lane driving, rightmost lane driving and weather condition (for example, rain, snow, strong wind, fog, etc.) and the like detected by the situation detector 121 by analyzing the front image taken by a front camera 311, or the vehicle driving information detecting the speed and acceleration information of the vehicle, and whether the vehicle is running in slope/curve/intersection/straight roads detected by the distance detector 122 by using 3-axis acceleration sensor 315, the low power driving of the radar sensors (SLR, SRR, RCR, FCR, FCLRR) can be controlled by outputting the switch control signal Sₒᵤₜ and selectively controlling on and off of 5 switches (SW₁˜SW₅).

For example, if the speed of the vehicle is less than 30 km/h, the operation of the FCLRR radar sensor can be off, or if the speed of the vehicle is more than 120 km/h, only the FCLRR radar sensor can be operated (S431, S435). For example, if the vehicle is running in a busy downtown at the speed less than 30 km/h (S431), since the 77 GHz long distance FCLRR radar sensor capable of detecting an object within 150 m of the front is not necessary, the distance detector 122 controls the corresponding switch so that the FCLRR radar sensor is not operated (S435). At this time, just 24 GHz Sensors (SLR, SRR, RCR, FCR) is operated. Also, if the vehicle is running in a freeway at the speed more than 120 km/h (S431), since the operations of the front 24 GHz radar sensors (SLR, SRR, RCR, FCR) are not effective in avoiding vehicle collision, the distance detector 122 controls the corresponding switch so that the sensors are off and only the 77 GHz FCLRR radar sensor is operated in order to monitor the front (S435). If the speed of the vehicle is 30 km/h˜120 km/h, all radar sensors (SLR, SRR, RCR, FCR, FCLRR) can be operated. Here, although the example, which the speed of its vehicle is less than 30 km/h or is more than 120 km/h, is described, if necessary, this driving speed boundary value can be changed and set to other values (for example, 30 km/h->60 km/h, 120 km/h->90 km/h).

Also, if the vehicle is running in a slope road or curve road (S432), according to the corresponding risk calculation of the collision manager 124, the collision avoidance device 125 can avoid the accident by maintaining the speed of its vehicle to the speed less than 90 km/h, and at this time, since the 77 GHz long distance FCLRR radar sensor capable of detecting an object within 150 m of the front is not necessary, the situation detector 121 can control the corresponding switch so that the FCLRR sensor is not operated (S435).

Also, if the weather condition is bad (rain, snow, strong wind, fog, etc.), or the ground state of the road is bad due to rain, snow, strong wind, fog, etc. or an unpaved road (S433), according to the corresponding risk calculation of the collision manager 124, the collision avoidance device 125 is configured to maintain avoidance of the accident according to the corresponding control by maintaining the speed of the vehicle to the speed less than a constant speed and determining the support of the acceleration/deceleration of the vehicle to assure a safe distance, and at this time, since the 77 GHz long distance FCLRR radar sensor capable of detecting an object within 150 m of the front is not necessary, the situation detector 121 can control the corresponding switch so that the FCLRR sensor is not operated (S435).

Also, if its vehicle is running in the leftmost lane, the operation of the left 24 GHz radar sensor (SLR) can be turned off, or if the vehicle is running in the rightmost lane, the operation of the right 24 GHz radar sensor (RLR) can be turned off (S434, S435). For example, if the vehicle is running in the leftmost lane with no driving lane on the left side of the vehicle (S434), since there is no moving vehicle on the left, the situation detector 121 turn off the operation of the left 24 GHz radar sensor (SLR) (S435). Also, if the vehicle is running in the rightmost lane with no driving lane on the right of its vehicle (S434), since there is no moving vehicle on the right, the situation detector 121 turn off the operation of the right 24 GHz radar sensor (SRR) (S435).

As described above, in the present invention, four 24 GHz radar sensors (SLR, SRR, RCR, FCR) and one 77 GHz radar sensor (FCLRR) are used, the total power consumption can be calculated by reflecting the operation power of the sensor itself P_{S} and the drive circuit power driving the sensor P_{D} as following Equation 2.

P=P_{S}+P_{D}=4(1+n)P₁+(1+3n)P₁=(5+7n)P₁ [Equation 2]

Here, 4(1+n)P₁ is a power by the four 24 GHz radar sensors (SLR, SRR, RCR, FCR), and (1+3n)P₁ is a power by the 77 GHz long distance FCLRR radar sensor. P₁ is a static power (V_{DD}I_{D}) of each radar, and n is a running time per 10 minutes (360 seconds), that is, it indicates n=(running time/10 minutes).

Hereinafter, as shown below in [Table 1], by classifying into two groups of running of the speed less than 90 km/h (group A) and running of the speed more than 90 km/h (group B) when the vehicle is running, the analysis example of the power consumption due to the operation of the radar sensors will be described.

TABLE 1
operation setting of the radar sensor according driving situations

| | | | | | | | POWER |
|---|---|---|---|---|---|---|---|
| | | | | | | | CONSUMP- |
| | | RADAR OPERATON | | | | | TION |
| | | FCLRR | FCR | RCR | SLR | SRR | EQUATION |
| GROUP | CASE 1 | Off | On | On | On | On | p = 4(1 + n)P₁ |
| A | CASE 2 | Off | On | Off | On | On | p = 3(1 + n)P₁ |
| | CASE 3 | Off | On | Off | On/ | Off/ | p = 2(1 + n)P₁ |
| | | | | | Off | On | |
| GROUP | CASE 1 | On | Off | On | On | On | p = (4 + 6n)P₁ |
| B | CASE 2 | On | Off | Off | On | On | p = (3 + 5n)P₁ |
| | CASE 3 | On | Off | Off | On/ | Off/ | p = (2 + 4n)P₁ |
| | | | | | Off | On | |

In the case of group A (running speed less than 90 km/h), for example, because the vehicle is running in the speed of the medium speed range, it is the case that the long distance radar sensor (FCLRR) of the center of the vehicle is turned off (FCLRR off) and only the short distance radar of the center is operated (FCR on).

In group A, in the case of the normal driving mode such as FCR on, RCR on, SLR on, SRR on, the situation detector 121 can generate the digital switch control signal (referring to FIG. 3) such as Sₒᵤₜ=(SW₁SW₂SW₃SW₄SW₅)=(01111), and at this time, the total power consumption is p=4(1+n)P₁ according to Equation 2.

In group A, in the case of night driving, slope driving, bad weather condition driving and bad road condition driving such as FCR on, RCR off, SLR on, SRR on, the situation detector 121 can generate the digital switch control signal (referring to FIG. 3) such as Sₒᵤₜ=(SW₁SW₂SW₃SW₄SW₅)=(01011), and at this time, the total power consumption is p=3(1+n) P₁ according to Equation 2.

In group A, in the case of night driving, slope driving, bad weather condition driving, bad road condition driving (RCR off), leftmost lane driving (SLR off, SRR on) or rightmost lane driving (SLR on, SRR off) such as FCR on, RCR off, SLR off or SRR off, the situation detector 121 can generate the digital switch control signal (referring to FIG. 3) such as Sₒᵤₜ=(SW₁SW₂SW₃SW₄SW₅)=(01001) or (01010), and at this time, the total power consumption is p=2(1+n)P₁ according to Equation 2.

In the case of group B (running speed more than 90 km/h), for example, because the vehicle is running in the speed exceeding the medium speed, it is the case that the long distance radar sensor (FCLRR) of the center of the vehicle is turned on (FCLRR on) and due to the duplication the short distance radar of the center is turned off (FCR off).

In group B, in the case of the normal driving mode such as FCR off, RCR on, SLR on, SRR on, the situation detector 121 can generate the digital switch control signal (referring to FIG. 3) such as Sₒᵤₜ=(SW₁SW₂SW₃SW₄SW₅)=(10111), and at this time, the total power consumption is p=(4+6n)P₁ according to Equation 2.

In group B, in the case of night driving, slope driving, bad weather condition driving and bad road condition driving such as FCR off, RCR off, SLR on, SRR on, the situation detector 121 can generate the digital switch control signal (referring to FIG. 3) such as Sₒᵤₜ=(SW₁SW₂SW₃SW₄SW₅)=(10011), and at this time, the total power consumption is p=(3+5n)P₁ according to Equation 2.

In group B, in the case of night driving, slope driving, bad weather condition driving, bad road condition driving (RCR off), leftmost lane driving (SLR off, SRR on) or rightmost lane driving (SLR on, SRR off) such as FCR off, RCR off, SLR off or SRR off, the situation detector 121 can generate the digital switch control signal (referring to FIG. 3) such as Sₒᵤₜ=(SW₁SW₂SW₃SW₄SW₅)=(10001) or (10010), and at this time, the total power consumption is p=(2+4n)P₁ according to Equation 2.

With respect to the case, for example, if P₁=V_{supply}I_{radar}=(5V)(60 mA)=300 mW, the analysis results such as [Table 2] and [Table 3] can be obtained.

TABLE 2
power consumption and fuel efficiency characteristic comparison for group A

| | NORMAL | | | | | |
|---|---|---|---|---|---|---|
| | OPERATION MODE | | | | POWER | FUEL |
| DRIVING | POWER | FUEL | POWER | FUEL | CONSUMPTION/ | CONSUMPTION |
| TIME | CONSUMPTION | CONSUMPTION | CONSUMPTION | CONSUMPTION | FUEL | REDUCTION |
| (MIN) | (W) | (cc) | (W) | (cc) | EFFICIENCY(%) | (cc) |
| | | | CASE 1 | | | |
| 10 | 22.5 | 2.25 | 13.2 | 1.32 | 70.45 | 0.93 |
| 20 | 43.5 | 8.7 | 25.2 | 5.04 | 72.62 | 3.66 |
| 30 | 64.5 | 19.35 | 37.2 | 11.16 | 73.39 | 8.19 |
| 40 | 85.5 | 34.2 | 49.2 | 19.68 | 73.78 | 14.52 |
| 50 | 106.5 | 53.25 | 61.2 | 30.6 | 74.02 | 22.65 |
| 60 | 127.5 | 76.5 | 73.2 | 43.92 | 74.18 | 32.58 |
| | | | CASE 2 | | | |
| 10 | 22.5 | 2.25 | 9.9 | 0.99 | 127.27 | 1.26 |
| 20 | 43.5 | 8.7 | 3.78 | 3.78 | 130.16 | 4.92 |
| 30 | 64.5 | 19.35 | 8.37 | 8.37 | 131.18 | 10.98 |
| 40 | 85.5 | 34.2 | 14.76 | 14.76 | 131.71 | 19.44 |
| 50 | 106.5 | 53.25 | 22.95 | 22.95 | 132.03 | 30.3 |
| 60 | 127.5 | 76.5 | 32.94 | 32.94 | 132.24 | 43.56 |
| | | | CASE 3 | | | |
| 10 | 22.5 | 2.25 | 6.6 | 0.66 | 240.91 | 1.59 |
| 20 | 43.5 | 8.7 | 12.6 | 2.52 | 245.24 | 6.18 |
| 30 | 64.5 | 19.35 | 18.6 | 5.58 | 246.77 | 13.77 |
| 40 | 85.5 | 34.2 | 24.6 | 9.84 | 247.56 | 24.36 |
| 50 | 106.5 | 53.25 | 30.6 | 15.3 | 248.04 | 37.95 |
| 60 | 127.5 | 76.5 | 36.6 | 21.96 | 248.36 | 54.54 |

TABLE 3
power consumption and fuel efficiency characteristic comparison for group B

| | NORMAL | | | | | |
|---|---|---|---|---|---|---|
| | OPERATION MODE | | | | POWER | FUEL |
| DRIVING | POWER | FUEL | POWER | FUEL | CONSUMPTION/ | CONSUMPTION |
| TIME | CONSUMPTION | CONSUMPTION | CONSUMPTION | CONSUMPTION | FUEL | REDUCTION |
| (MIN) | (W) | (cc) | (W) | (cc) | EFFICIENCY(%) | (cc) |
| | | | CASE 1 | | | |
| 10 | 22.5 | 2.25 | 19.2 | 1.92 | 17.19 | 0.33 |
| 20 | 43.5 | 8.7 | 37.2 | 7.44 | 16.94 | 1.26 |
| 30 | 64.5 | 19.35 | 55.2 | 16.56 | 16.85 | 2.79 |
| 40 | 85.5 | 34.2 | 73.2 | 29.28 | 16.80 | 4.92 |
| 50 | 106.5 | 53.25 | 91.2 | 45.6 | 16.78 | 7.65 |
| 60 | 127.5 | 76.5 | 109.2 | 65.52 | 16.76 | 10.98 |
| | | | CASE 2 | | | |
| 10 | 22.5 | 2.25 | 15.9 | 1.59 | 41.51 | 0.66 |
| 20 | 43.5 | 8.7 | 30.9 | 6.18 | 40.78 | 2.52 |
| 30 | 64.5 | 19.35 | 45.9 | 13.77 | 40.52 | 5.58 |
| 40 | 85.5 | 34.2 | 60.9 | 24.36 | 40.39 | 9.84 |
| 50 | 106.5 | 53.25 | 75.9 | 37.95 | 40.32 | 15.3 |
| 60 | 127.5 | 76.5 | 54.54 | 54.54 | 40.26 | 21.96 |
| | | | CASE 3 | | | |
| 10 | 22.5 | 2.25 | 12.6 | 1.26 | 78.57 | 0.99 |
| 20 | 43.5 | 8.7 | 24.6 | 4.92 | 76.83 | 3.78 |
| 30 | 64.5 | 19.35 | 36.6 | 10.98 | 76.23 | 8.37 |
| 40 | 85.5 | 34.2 | 48.6 | 19.44 | 75.93 | 14.76 |
| 50 | 106.5 | 53.25 | 60.6 | 30.3 | 75.74 | 22.95 |
| 60 | 127.5 | 76.5 | 72.6 | 43.56 | 75.62 | 32.94 |

As Table 2 and Table 3, for the case in which all of 5 sensors are operated which the vehicle is running in the speed less than 90 km/h during 1 hour, when the method proposed by the present invention is applied, the power consumption can be reduced to maximum about 250% and the fuel consumption can be reduced to maximum about 55 cc. Also, for the case in which all of 5 sensors are operated which the vehicle is running in the speed more than 90 km/h during 1 hour, when the method proposed by the present invention is applied, the power consumption can be reduced to maximum about 76% and the fuel consumption can be reduced to maximum about 33 cc.

FIG. 6 is a flow chart of a process of a collision avoidance and vehicle control algorithm of an apparatus for avoiding a vehicle collision according to an embodiment of the present invention.

As described in FIG. 4, the database 123 maintains data measured or calculated in the converged sensors 110, the situation detector 121 and the distance detector 122, so that the measured or calculated data can be used by the comparison calculation of each part (S440). In this process, if all data required to the collision avoidance algorithm of the present invention are collected by completing the measurement, calculation, analysis and detection, etc. in the converged sensors 110, the situation detector 121 and the distance detector 122 (S450), in the collision managing and avoidance step S460 (referring to FIG. 4), the collision manager 124 calculates and manages the speed/acceleration of the vehicle, the speed/acceleration of a preceding vehicle, a collision risk value depending on the relative distance from a preceding vehicle and a surrounding object while tracking the change of the relative voltage difference (ΔV) or the relative phase difference (Δθ) by using the database information of the database 123, and the collision avoidance device 125 determines front, side, rear collision warnings, assistance for a lane change, warning for rear cross-collision and acceleration/deceleration support, etc. according to the collision risk received from the collision manager 124 by using the database information.

In the vehicle control and driving managing step S470 (referring to FIG. 4), the vehicle control and driving algorithm is applied, and the vehicle controller 130 is configured to perform the angle control of the front wheel of the vehicle for changing the lane through the vehicle acceleration by controlling the steering wheel driving motor 131 interoperated with the wheel/brake system 133, perform the rear wheel of the vehicle for accelerating the vehicle by controlling the DC driving motor 132, and perform the control for decelerating the vehicle by the actuator 134 interoperated with the wheel/brake system 133 for avoiding a collision, according to the collision risk received from the collision manager 124. Also, in order to determine whether the steering wheel is operated, whether the steering wheel sensor 114 and brake pedal sensor 113 are operated, whether the DC motor is operated, whether the speed of the vehicle is controlled, etc. according to the driving condition such the road condition and the weather condition, the driving manager 140 can receive the information for the operating signals of the brake pedal sensor 113, the steering wheel sensor 114, steering wheel driving motor 131, the DC driving motor 132, actuator 134, etc. from ECU (Engine Control Unit) as driving information, and analyze the driving pattern depending on the driving information.

Thus, the warning and driving changer 150 can output the warning for notifying the collision risk to a speaker according to the collision avoidance algorithm of the collision avoidance responder 120 or display the warning to a display device, and controls each part required for changing the control of the vehicle for a predetermined running performance such as soft driving comfort, etc. by changing the vehicle driving such as the acceleration/deceleration of the vehicle, etc. according to the driving control based on the driving pattern analyzed by the driving manager 140.

Referring to FIG. 6A, FIG. 6B, and FIG. 6C (S610˜S657), the collision managing and collision avoidance step (S460) and the vehicle control and driving managing step (S470) will be explained in detail.

First, referring to FIG. 6A, in order to support the change of the left lane for the vehicle, by using FCR, SLR, RCR sensors, the algorithm for controlling the acceleration and deceleration of the vehicle according to the collision managing/collision avoidance and the vehicle control/driving managing for the surrounding environment of the front, the left side and the rear will be explained. At this time, it is preferable that FCLRR sensor is turned off, but turning on is possible in some cases.

For example, the vehicle speed limit is designated to a predetermined speed such as medium speed driving, etc. (for example, less than 120 km/h), and while the acceleration of the vehicle is performed according to the information for the road condition and driving environment analyzed by the situation detector 121 and the vehicle driving information analyzed by the distance detector 122 (S610), the distance detector 122 can measure the distance from the vehicle to vehicles of the front and the left side of the front by using the relative voltage difference (ΔV) or relative phase difference (Δθ) as described above according to the operation of FCR, SLR sensors (S611). At this time, the distance from the vehicle to vehicles the front and the left side of the front is not between Y1˜Y3(m) (S612), and if the distance is less than Y1˜Y3 (That is, less than Y1) (S613), the deceleration of the vehicle is performed by interoperating the vehicle controller 130 and the driving manager 140 according to the corresponding collision risk analysis of the collision manager 124 and the deceleration determination of the collision avoidance device 125 (S614). If the distance is more than Y1˜Y3 (that is, more than Y3) (S613), the acceleration of the vehicle is performed by interoperating the vehicle controller 130 and the driving manager 140 according to the corresponding collision risk analysis of the collision manager 124 and the acceleration determination of the collision avoidance device 125 (S610).

In the above description, while the distance from the vehicle to vehicles on the front and the left side of the front is between Y1˜Y3(m) (S612), if it is determined that there is no vehicle in the left lane of the front (S615), the distance detector 122 measures the distance from its vehicle to vehicles on the rear and the left side of the rear by using the relative voltage difference (ΔV) or relative phase difference (Δθ) as described above according to the operation of RCR, SLR sensors (S620). At this time, the distance from the vehicle to vehicles on the rear and the left side of the rear is not between Y2˜Y3(m) (S621), and if the distance is less than Y2˜Y3 (That is, less than Y2) (S622), the deceleration of the vehicle is performed by interoperating the vehicle controller 130 and the driving manager 140 according to the corresponding collision risk analysis of the collision manager 124 and the deceleration determination of the collision avoidance device 125 (S623). If the distance is more than Y2˜Y3 (that is, more than Y3) (S622), the acceleration of the vehicle is performed by interoperating the vehicle controller 130 and the driving manager 140 according to the corresponding collision risk analysis of the collision manager 124 and the acceleration determination of the collision avoidance device 125 (S610).

Here, although the example which Y1 and Y2 are different values (for example, Y1<Y2 or Y1>Y2) is explained, the values may be same values in some cases, and although the example which Y3 in step S612 and Y3 in step S621 are same values is explained, the values may be different in some cases.

In the above description, while the distance from the vehicle to vehicles on the rear and the left side of the rear is between Y2˜Y3(m) (S621), if it is determined that there is no vehicle in the left lane of the rear (S624), while the acceleration of the vehicle is performed by interoperating the vehicle controller 130 and the driving manager 140 (S625), it can be determined that the lane is changed to the left lane and the corresponding control can be performed (S626).

Next, referring to FIG. 6B, in order to support the change of the right lane for the vehicle, by using FCR, SRR, RCR sensors, the algorithm for controlling the acceleration and deceleration of the vehicle according to the collision managing/collision avoidance and the vehicle control/driving managing for the surrounding environment of the front, the right side and the rear will be explained. At this time, it is preferable that FCLRR sensor is turned off, but turning on is possible in some cases.

For example, the vehicle speed limit is designated to a predetermined speed such as medium speed driving, etc. (for example, less than 120 km/h), and while the acceleration of the vehicle is performed according to the information for the road condition and driving environment analyzed by the situation detector 121 and the vehicle driving information analyzed by the distance detector 122 (S630), the distance detector 122 can measure the distance from the vehicle to vehicles on the front and the right side of the front by using the relative voltage difference (ΔV) or relative phase difference (Δθ) as described above according to the operation of FCR, SRR sensors (S631). At this time, the distance from the vehicle to vehicles on the front and the right side of the front is not between Y1˜Y4(m) (S632), and if the distance is less than Y1˜Y4 (That is, less than Y1) (S633), the deceleration of the vehicle is performed by interoperating the vehicle controller 130 and the driving manager 140 according to the corresponding collision risk analysis of the collision manager 124 and the deceleration determination of the collision avoidance device 125 (S634). If the distance is more than Y1˜Y4 (that is, more than Y4) (S633), the acceleration of the vehicle is performed by interoperating the vehicle controller 130 and the driving manager 140 according to the corresponding collision risk analysis of the collision manager 124 and the acceleration determination of the collision avoidance device 125 (S630).

In the above description, while the distance from the vehicle to vehicles on the front and the right side of the front is between Y1˜Y4(m) (S632), if it is determined that there is no vehicle on the right lane of the front (S635), the distance detector 122 measures the distance from the vehicle to vehicles on the rear and the right side of the rear by using the relative voltage difference (ΔV) or relative phase difference (Δθ) as described above according to the operation of RCR, SRR sensors (S640). At this time, the distance from the vehicle to vehicles on the rear and the right side of the rear is not between Y2˜Y4(m) (S641), and if the distance is less than Y2˜Y4 (That is, less than Y2) (S642), the deceleration of the vehicle is performed by interoperating the vehicle controller 130 and the driving manager 140 according to the corresponding collision risk analysis of the collision manager 124 and the deceleration determination of the collision avoidance device 125 (S643). If the distance is more than Y2˜Y4 (that is, more than Y4) (S642), the acceleration of the vehicle is performed by interoperating the vehicle controller 130 and the driving manager 140 according to the corresponding collision risk analysis of the collision manager 124 and the acceleration determination of the collision avoidance device 125 (S640).

Here, although the example which Y1 and Y2 are different values (for example, Y1<Y2 or Y1>Y2) is explained, the values may be same values in some cases, and although the example which Y4 in step S632 and Y4 in step S641 are same values is explained, the values may be different in some cases.

In the above description, while the distance from the vehicle to vehicles on the rear and the right side of the rear is between Y1˜Y4(m) (S641), if it is determined that there is no vehicle on the right lane of the rear (S644), while the acceleration of the vehicle is performed by interoperating the vehicle controller 130 and the driving manager 140 (S645), it can be determined that the lane is changed to the right lane and the corresponding control can be performed (S646).

Next, referring to FIG. 6C, in order to support the acceleration and deceleration when the vehicle is normally running, by the FCLRR sensor, the algorithm for controlling the acceleration and deceleration of the vehicle according to the collision managing/collision avoidance and the vehicle control/driving managing for the surrounding environment of the front will be explained. At this time, it is preferable that FCR sensor is turned off, but turning on is possible in some cases.

For example, the vehicle speed limit is designated to a predetermined speed such as high speed driving, etc. (for example, more than 120 km/h), and while the acceleration of the vehicle is performed according to the information for the road condition and driving environment analyzed by the situation detector 121 and the vehicle driving information analyzed by the distance detector 122 (S650), the distance detector 122 can measure the distance from its vehicle to front vehicle by using the relative voltage difference (ΔV) or relative phase difference (Δθ) as described above according to the operation of FCLRR sensor (S651). At this time, the distance from the vehicle to the front vehicle is not a predetermined distance X(m) (S652), and if the distance is more than X (S653), the acceleration of the vehicle is performed by interoperating the vehicle controller 130 and the driving manager 140 according to the corresponding collision risk analysis of the collision manager 124 and the acceleration determination of the collision avoidance device 125, and if the distance is less than X (S653), the deceleration of the vehicle is performed by interoperating the vehicle controller 130 and the driving manager 140 according to the corresponding collision risk analysis of the collision manager 124 and the deceleration determination of the collision avoidance device 125 (S654).

In the above description, the distance from the vehicle to the front vehicle is to be X by the deceleration, etc. (S652), and when moving away more and more, it can be determined that there is no vehicle in the front lane (S655), and after that, when it is determined that the distance from its vehicle to the front vehicle is more than X (S656), the acceleration of the vehicle is performed by interoperating the vehicle controller 130 and the driving manager 140 according to the corresponding collision risk analysis of the collision manager 124 and the acceleration determination of the collision avoidance device 125 (S657).

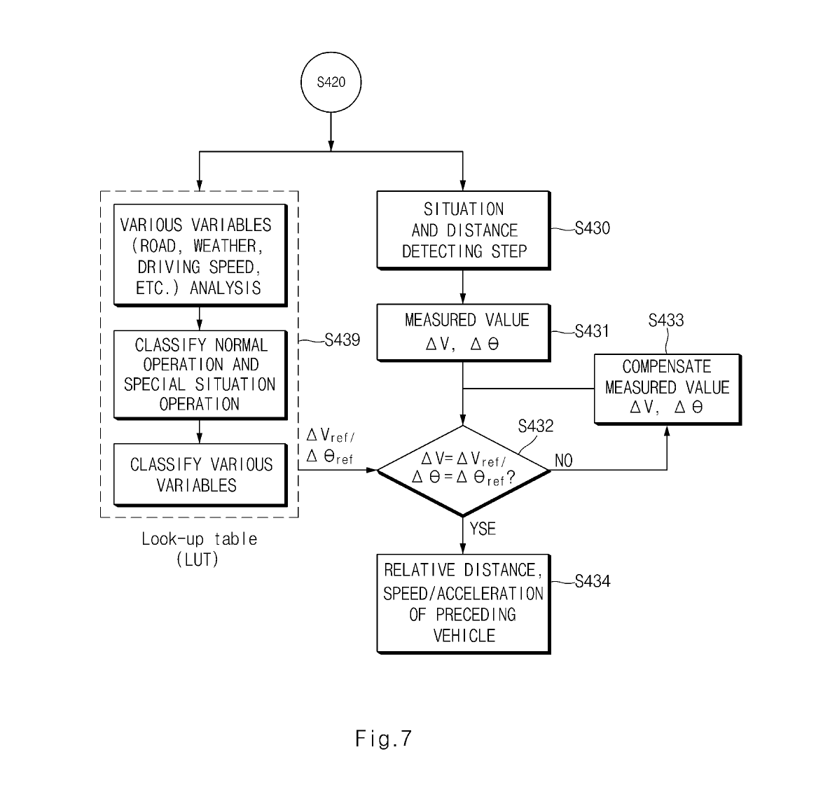

FIG. 7 is flow chart of a process of an example of a database managing algorithm of an apparatus for avoiding a vehicle collision according to an embodiment of the present invention.

As described in FIG. 4, after the converged sensor operating step S420 and the situation and distance detecting step are performed, the database 123 maintains data measured or calculated in the converged sensors 110, the situation detector 121 and the distance detector 122, so that the measured or calculated data can be used by the comparison calculation in each part such as the collision manager 124, the collision avoidance device 125, etc.

In particular, by using a predetermined relative distance calculation algorithm, the distance detector 122 compares the radar signal (wireless microwave signal) generated from the radar sensors 111, 112 and the received signal reflected from the preceding vehicle and the surrounding object, generates the relative voltage difference (ΔV) or relative phase difference (Δθ), and it is stored and managed in the database 123 (S431), and if the each of the relative voltage difference (ΔV) and relative phase difference (Δθ) is same with each of a reference voltage difference (ΔV_{ref}), a reference phase difference (Δθ_{ref}) in a predetermined error range (S432), the distance detector 122 can calculate the relative distance from the preceding vehicle or a surrounding object, the speed/acceleration of the preceding vehicle, etc. by referencing look-up table (LUT), and the calculated values can be stored and managed in a database (S434).

In LUT of the database 123, according to the information for the road condition and the driving environment such as slope/curve/intersection/straight driving, night driving, ground state of a road, leftmost lane driving and rightmost lane driving, weather condition (for example, rain, snow, strong wind, fog, etc.), etc., by classifying the case of a normal driving situation and the case of a special driving situation and synthesizing the variables capable of affecting the relative voltage difference (ΔV) and the relative phase difference (Δθ), the information for the relative distance from the preceding vehicle or the surrounding object, the speed/acceleration of a preceding vehicle, etc. (S434), corresponding to the reference voltage difference (ΔV_{ref}) and the reference phase difference (Δθ_{ref}) in the corresponding road condition and driving environment can be stored and managed in the database (S439).

Using this, in step S432, if each of the measured relative voltage difference (ΔV) and the measured relative phase difference (Δθ) is not same with each of a reference voltage difference (ΔV_{ref}), a reference phase difference (Δθ_{ref}) in a predetermined error range (S432), the distance detector 122 performs the measurement value compensation until each of the measured relative voltage difference (ΔV) and the measured relative phase difference (Δθ) is same with each of a reference voltage difference (ΔV_{ref}), a reference phase difference (Δθ_{ref}) in a predetermined error range by measuring the relative voltage difference (ΔV) and the relative phase difference (Δθ) again (S433). Accordingly, by referencing LUT, the information for the relative distance from a preceding vehicle or a surrounding object, the speed/acceleration of a preceding vehicle, etc. corresponding to the reference voltage difference (ΔV_{ref}) and the reference phase difference (Δθ_{ref}) in the corresponding road condition and driving environment can be stored and managed (S439).

In the above description, the present invention has been described through specific elements, embodiments, and drawings, it is only provided to assist in a comprehensive understanding of the present invention, the present invention is not limited to the embodiments, and it will be understood by those skilled in the art that the present invention may be implemented as various modifications and variations without departing from the spirit of the present invention. Accordingly, the scope of the present invention is recited in the appended claims, not the above descriptions, and all differences within the equivalent scope of the present invention will be construed as being included in the present invention.

What is claimed is:

1. A method for avoiding a collision of a vehicle with a low power consumption based on a converged radar sensor mounted on the vehicle comprising steps of:
(a) operating a plurality of radar sensors;
(b) detecting a road condition or a driving environment by analyzing an image of a front camera;
(c) obtaining speed information of the vehicle analyzed by using an acceleration sensor and driving information including information for a surrounding vehicle or a surrounding object analyzed by using a radar signal generated by the plurality of radar sensors and a corresponding reflection signal; and
(d) supporting a driving state change including a speed of the vehicle or lane change by determining whether a risk for the collision with the surrounding vehicle or the surrounding object exists, while controlling an operation of one front long distance radar sensor and a short distance radar sensor of residual front, rear, or side of the plurality of radar sensors, according to the driving environment or the driving information.

2. The method for avoiding a vehicle collision according to claim 1, wherein in the (d) step, the method supports controlling the operation of the plurality of radar sensors and changing the driving state of the vehicle by reflecting at least one of a ground state of a road, whether to run in a slope road, whether to run in a curve road, whether to run in an intersection road, whether to run straight, whether to run at night, whether to run in a leftmost lane, whether to run in a rightmost lane, a weather condition, a speed or acceleration of the vehicle, a relative distance from a preceding vehicle or the surrounding object, or a speed or acceleration of the preceding vehicle.

3. The method for avoiding a vehicle collision according to claim 1, wherein in (d) step, operation of the front long distance radar sensor is turned off in a speed less than a predetermined speed of the vehicle, and operation of the front long distance radar sensor is turned on in a speed more than a predetermined speed of the vehicle.

4. The method for avoiding a vehicle collision according to claim 1, wherein in the (d) step, if the vehicle is running in a slope road, or if a state of a road includes a bad weather condition including rain, snow, strong wind or fog situation, or unpaved road situation, operation of the front long distance radar sensor is turned off.

5. The method for avoiding a vehicle collision according to claim 1, wherein in step (d), if the vehicle is running in a leftmost lane, operation of left side short distance radar sensor of the plurality of radar sensors is turned off, or if the vehicle is running in a rightmost lane, operation of right side short distance radar sensor of the plurality of radar sensors is turned off.

6. The method for avoiding a vehicle collision according to claim 1, wherein in step (d), while supporting a control of acceleration or deceleration of its vehicle by comparing the distance from a vehicle of the front and a left side of the front measured using operation of the front short distance radar sensor and the left side short distance radar sensor of the plurality of radar sensors and a predetermined distance, when determined that there is no vehicle in a left lane of the front,
while supporting a control of acceleration or deceleration of the vehicle by comparing the distance from a vehicle on the rear and a left side of the rear measured using operation of the front short distance radar sensor and the left side short distance radar sensor of the plurality of radar sensors and a predetermined distance, when determined that there is no vehicle in a left lane of the rear, controls so as to support the acceleration of its vehicle and to change the lane into the left side lane.

7. The method for avoiding a vehicle collision according to claim 1, wherein in step (d), while supporting a control of acceleration or deceleration of the vehicle by comparing the distance from a vehicle on the front and a right side of the front measured using operation of the front short distance radar sensor and the right side short distance radar sensor of the plurality of radar sensors and a predetermined distance, when determined that there is no vehicle in a right lane of the front,
while supporting a control of acceleration or deceleration of its vehicle by comparing the distance from a vehicle of the rear and a right side of the rear measured using operation of the front short distance radar sensor and the right side short distance radar sensor of the plurality of radar sensors and a predetermined distance, when determined that there is no vehicle in a right lane of the rear, controls so as to support the acceleration of its vehicle and to change the lane into the right side lane.

8. The method for avoiding a vehicle collision according to claim 1, wherein in step (d), supporting a control of acceleration or deceleration of the vehicle by comparing the distance from a preceding vehicle measured using operation of the front long distance radar sensor of the plurality of radar sensors and a predetermined distance, and even when determined that there is no vehicle in the front, supporting the acceleration of the vehicle.

9. The method for avoiding a vehicle collision according to claim 8, wherein if a vehicle speed limit exceeds a predetermined high driving speed, only the front long distance radar sensor of the plurality of radar sensors is operated.

10. The method for avoiding a vehicle collision according to claim 1, wherein in step (c), by comparing a radar signal generated by the plurality of radar sensors and a corresponding reflection signal, measures a relative voltage difference and a relative phase difference until each of the relative voltage difference and the relative phase difference is same with each of a reference voltage difference and a reference phase difference in a predetermined error range, and by referencing a lookup table of a database, calculates a relative distance from a preceding vehicle or the surrounding object or information for a speed or acceleration of the preceding vehicle corresponding to the reference voltage difference and the reference phase difference as a part of the driving information.

11. An apparatus for avoiding a vehicle collision with low power consumption based on a converged radar sensor mounted on the vehicle comprising:
a plurality of radar sensors; and
a collision avoidance responder configured to perform control of the plurality of radar sensors with a low power consumption and driving control for avoiding a collision of the vehicle,
wherein the collision avoidance responder comprises a situation detector configured to detect a road condition or a driving environment by analyzing an image of a front camera; and a distance detector configured to obtain speed information of the vehicle analyzed by using an acceleration sensor and driving information including information for a surrounding vehicle or a surrounding object analyzed by using a radar signal generated by the plurality of radar sensors and a corresponding reflection signal,
the collision avoidance responder supports a driving state change including a speed of its vehicle or lane change by determining whether a risk for a collision with the surrounding vehicle or the surrounding object exists, while controlling an operation of a front long distance radar sensor and a short distance radar sensor of residual front, rear, or side of the plurality of radar sensors, according to the driving environment or the driving information.

12. The apparatus for avoiding a vehicle collision according to claim 11, wherein the plurality of radar sensors includes the front long distance radar sensor, a front short distance radar sensor, a rear short distance radar sensor, a left side short distance radar sensor, and a right side short distance radar sensor.

13. The apparatus for avoiding a vehicle collision according to claim 11, wherein the plurality of radar sensors includes the front long distance radar sensor operated in 77 GHz, and residual four short distance radar sensors operated in 24 GHz.

14. The apparatus for avoiding a vehicle collision according to claim 11, the distance detector turns off operation of the front long distance radar sensor in a speed less than a predetermined speed of its vehicle, and turns on operation of the front long distance radar sensor in a speed more than a predetermined speed of its vehicle.

15. The apparatus for avoiding a vehicle collision according to claim 11, wherein the situation detector turns off operation of the front long distance radar sensor, if its vehicle is running in a slope road, or if a state of a road includes a bad weather condition including rain, snow, strong wind or fog situation, or unpaved road situation.

16. The apparatus for avoiding a vehicle collision according to claim 11, the situation detector turns off operation of left side short distance radar sensor of the plurality of radar sensors, if its vehicle is running in a leftmost lane, or turns off operation of right side short distance radar sensor of the plurality of radar sensors, if its vehicle is running in a rightmost lane.

17. The apparatus for avoiding a vehicle collision according to claim 11, the collision avoidance responder, while supporting a control of acceleration or deceleration of its vehicle by comparing the distance a vehicle of from the front and a left side of the front measured using operation of the front short distance radar sensor and the left side short distance radar sensor of the plurality of radar sensors and a predetermined distance, when determined that there is no vehicle in a left lane of the front,
while supporting a control of acceleration or deceleration of the vehicle by comparing the distance from a vehicle of the rear and a left side of the rear measured using operation of the front short distance radar sensor and the left side short distance radar sensor of the plurality of radar sensors and a predetermined distance, when determined that there is no vehicle in a left lane of the rear, controls so as to support the acceleration of its vehicle and to change the lane into the left side lane.

18. The apparatus for avoiding a vehicle collision according to claim 11, the collision avoidance responder, while supporting a control of acceleration or deceleration of the vehicle by comparing the distance from a vehicle of the front and a right side of the front measured using operation of the front short distance radar sensor and the right side short distance radar sensor of the plurality of radar sensors and a predetermined distance, when determined that there is no vehicle in a right lane of the front,
while supporting a control of acceleration or deceleration of its vehicle by comparing the distance from a vehicle of the rear and a right side of the rear measured using operation of the front short distance radar sensor and the right side short distance radar sensor of the plurality of radar sensors and a predetermined distance, when determined that there is no vehicle in a right lane of the rear, controls so as to support the acceleration of its vehicle and to change the lane into the right side lane.

19. The apparatus for avoiding a vehicle collision according to claim 11, the collision avoidance responder supports a control of acceleration or deceleration of the vehicle by comparing the distance from a preceding vehicle measured using operation of the front long distance radar sensor of the plurality of radar sensors and a predetermined distance, and supports the acceleration of its vehicle, even if it is determined that there is no vehicle in the front.
